(19) United States
(12) Patent Application Publication
(10) Pub. No.: US 2007/0062735 A1
(43) Pub. Date: Mar. 22, 2007

(54) REMOVABLE ELECTRICAL OUTLET PROTECTIVE COVER

(76) Inventor: Troy Craig, Maple Valley, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/533,662

(22) Filed: Sep. 20, 2006

Related U.S. Application Data
(60) Provisional application No. 60/718,915, filed on Sep. 20, 2005.

(51) Int. Cl. H02G 3/18

(52) U.S. Cl. 174/660

(57) ABSTRACT

This invention relates to a removable cover for an electrical outlet. A base plate is coupled to the wall. The base plate contains one or more slots for receiving a protective cover. The protective cover has tabs thereon whose location correspond to the location in the base plate. The protective cover is attached to the base plate by inserting the tabs into the base plate. The protective cover prevents electrical cords from being inadvertently removed from the wall plug.

### BACKGROUND OF THE INVENTION

1. Field of the Invention

The present invention generally relates to protective covers and, more specifically, to a removable protective cover for electrical outlets.

2. Description of the Related Art

Electrical outlets have long been a source of danger for children due to their unseen electrical power. There has long been a need to protect children from such dangers both when the electrical outlets are in and out of use.

There exist plugs that may be inserted into an electrical outlet to protect children from the outlet however such plugs need to be removed when the outlet is in use. Thus, such plugs are of no use when something is plugged into an electrical outlet. Electrical outlets, however, remain dangerous even with a device plugged into them. For example, although in most cases, an electric plug inserted into an electrical outlet does not expose its prongs, if the cord is partially removed, the prongs may be exposed when still making electrical contact. Exposed prongs are dangerous as a child's small finger, or device the child is holding, such as a fork, may short the prongs together to shock the child.

A partially removed electric plug may occur despite the fact that when the electrical plug is inserted into an electrical outlet it may initially be plugs all the way in. After use of a device associated with the electrical cord, such as a vacuum cleaner, the plug may be partially pulled-out simply through use of the device. As such, there exists a need to protect electrical outlets both when in use and when not in use. There further exists a need to reduce the likelihood that an electrical cord associated with a device in use will be unintentionally pulled out of an electrical socket.

### BRIEF SUMMARY OF THE INVENTION

This invention relates to a removable cover for an electrical outlet. A base plate is coupled to the wall. The base plate contains one or more slots for receiving a protective cover. The protective cover has tabs thereon whose location correspond to the location in the base plate. The protective cover is attached to the base plate by inserting the tabs into the base plate. The protective cover prevents electrical cords from being inadvertently removed from the wall plug.

### BRIEF DESCRIPTION OF THE SEVERAL VIEWS OF THE DRAWING(S)

FIG. 1 is an isometric exploded view of the protective cover being attached to the wall plate.

FIG. 2 is a front side elevation of the wall plate.

FIG. 3 is a back side elevation of the wall plate.

FIG. 4 is an isometric view of the wall plate.

FIG. 5 is an isometric inside view of the protective cover.

FIG. 6 is a front view of the protective cover.

FIG. 7 is a bottom view of the protective cover.

FIG. 8 is an isometric view of the protective cover showing that different visual display material may be attached to the protective cover.

FIG. 9 shows an electrical plug 127 in a socket with the cord 125 extending out of the bottom of protective cover 110.

### DETAILED DESCRIPTION OF THE INVENTION

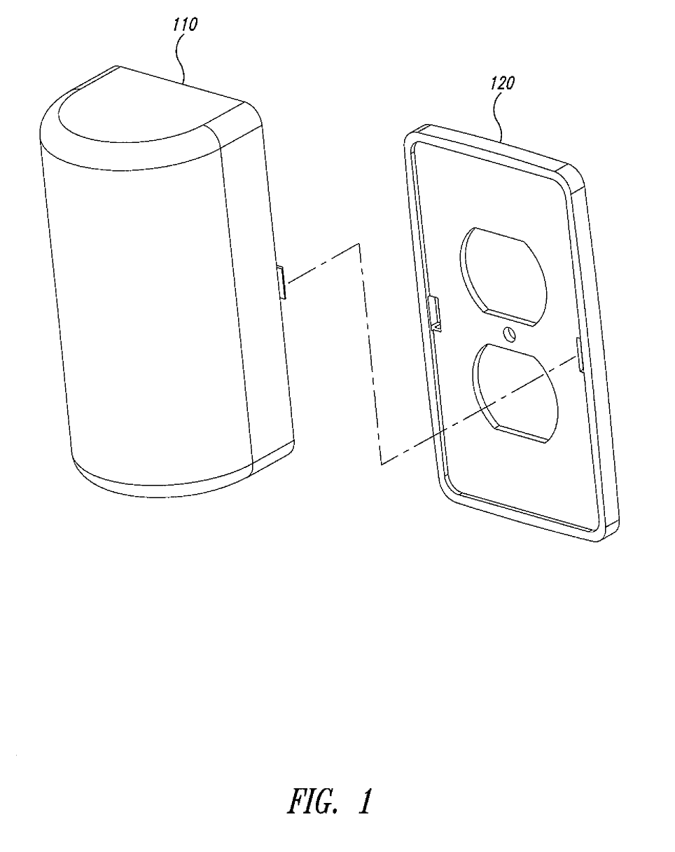

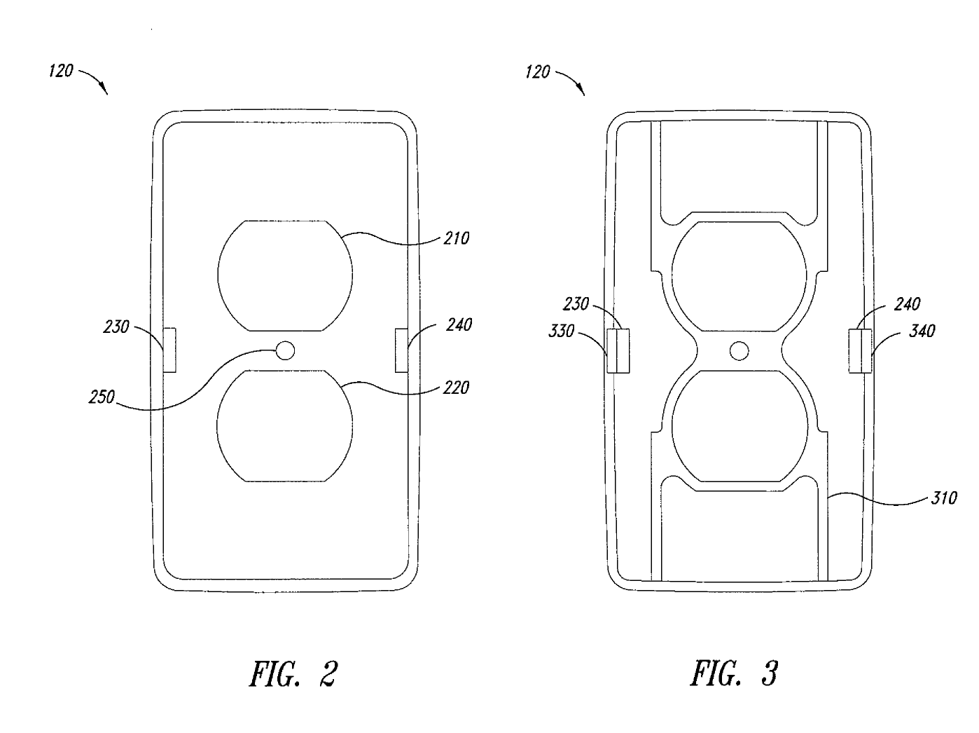

Referring first to FIG. 1, embodiments may include a protective cover 110 and a base plate 120. The base plate 120 can be better understood with reference to FIGS. 2, 3 and 4, showing a top view, a bottom view and an isometric view of the base plate 120. The base plate 120 may include outlet apertures 210 and 220 in which an electrical outlet may be exposed. Base plate 120 may also include a screw aperture 250 to allow for a screw, or other means of fastening, to secure the base plate 120 to an electrical outlet. Although a single screw aperture 250 is shown, other embodiments may include more than one screw aperture 250.

The base plate 120 may also include tab apertures, such as tab apertures 230 and 240. Although an embodiment with two tab apertures on opposite edges of the base plate 120 is shown, other embodiments are envisaged. For example, in other embodiments the base plate 120 may include only a single tab located on a single edge. Still other embodiments may include a third tab located on an edge perpendicular to the edges of tab apertures 230 and 240. Still other embodiments may include tab apertures on all edges or multiple tab apertures per edge.

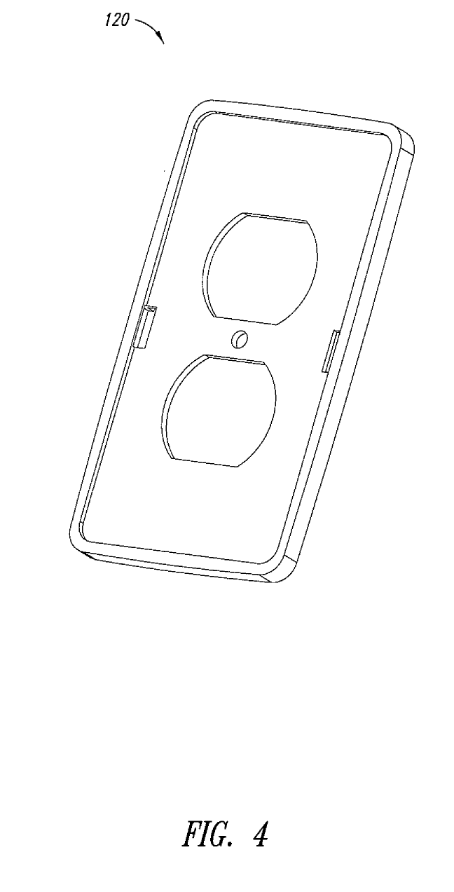

Referring to FIG. 3, tab apertures 240 may include a portion that is recessed, such as recessed portions 330 and 340. Recessed portion 330 may be a portion of the base plate 120 that is recessed and connected to the tab aperture 230 and 240. As explained bellow, the recessed portions 330 and 340 allow outward protruding tabs to be received. Embodiments with inward protruding tabs may not include such apertures, depending on the configuration of a support portion 310. For example, if the support portion 310 is not located near the apertures 230 and 240, there may be clearance for inward protruded tabs without the need for recessed portions 330 and 340.

The base plate 120 may also include the support portion 310 to increase rigidity and strength of the base plate 120. The support portion 310 may include portions of the base plate 120 with an increased thickness that add structural rigidity and increase the strength of the base plate 120. In other embodiments the base plate 120 may be of a uniform thickness and thus not include the support portion 310, although in preferred embodiments the base plate 120 includes a support portion 310 to minimize the amount of material needed to construct the base plate 120. Although a specific embodiment of the support portion is shown in FIG. 3, many different arrangements are envisaged. For example, the support portion 120 may extend to opposite edges, or to only a single edge. The various features of the base plate 120 may be better appreciated with reference to an isometric view shown in FIG. 4.

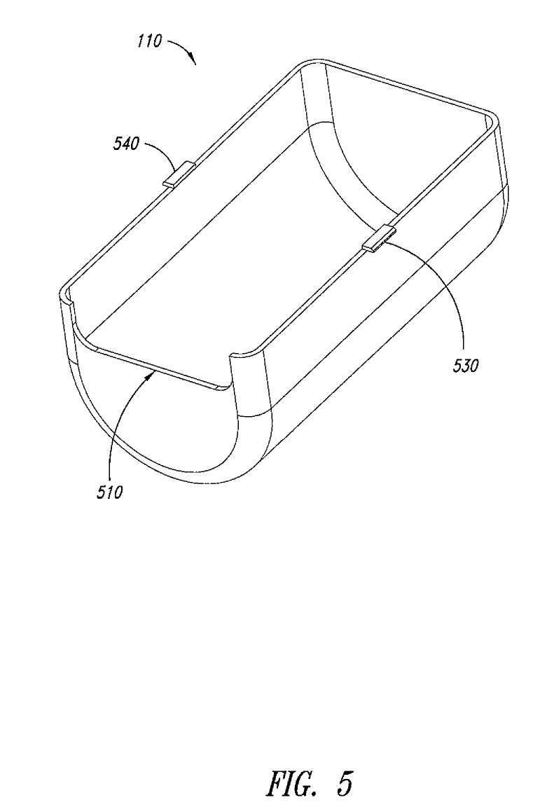

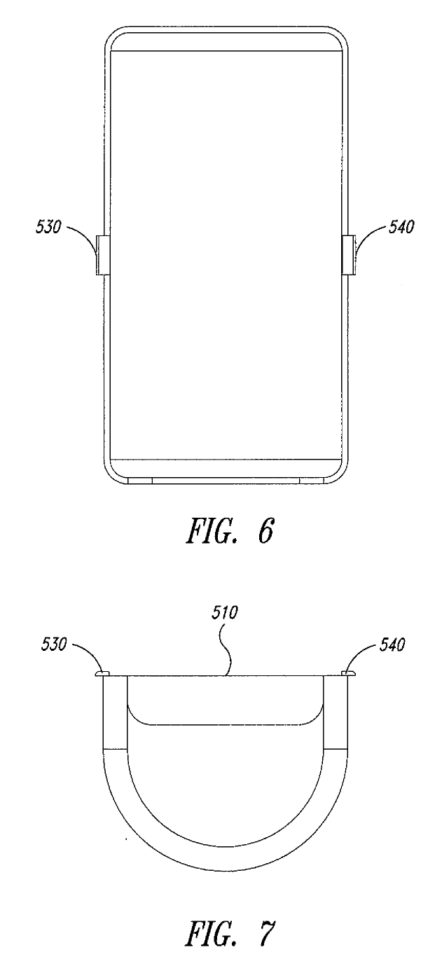

The protective cover 110 may be better understood with reference to FIGS. 5-7. Embodiments of the protective cover include tabs 530 and 540. The tabs 530 and 540 may be located to mate with the tab apertures 230 and 240 of the base plate 120 respectively such that the tabs 540 and 540 may “clip” into the tab aperture 230 and 240 to securely fasten the protective cover to the base plate 120. The clipping may be accomplished through the use of portions that protrude outwards. Such portions may be used to fit into the recessed portions 330 and 340. Once coupled to the base plate 120, the protective cover 110 may be removed by simply applying an inward pressure to the protective cover such that the tabs 530 and 540 may be slid out of the tab apertures 230 and 240. In other embodiments, the tabs may protrude inwards. In such embodiments the application of pressure inwards would not release the tabs and thus the protective cover would be more difficult to be removed such that it is “locked” for added safety.

The tabs 530 and 540 allow the protective cover to be selectively removable. Thus, if the electrical outlet associated with the base plate 120 is not in use, the protective cover 110 may be used on another base plate 120 that is associated with an electrical outlet that is in use. Such versatility allows for the purchase of fewer protective covers 110 than base plates 120. Further, if a piece of furniture is placed directly in front of the base plate 120 the protective cover may be removed to allow the piece of furniture to more closely abut the wall.

One tremendous advantage of the invention is the ability of the user to easily attach or remove the protective cover to or from any wall socket in the entire home. A suitable base plate 120 is provided in many rooms of the house. To the standard user, the base plate appears to be a standard wall socket. The only difference being that it has mating slots for the attachment of the cover 110. The user may have over 20 or 30 such base plates on the electrical outlets throughout the home or office. The user can then purchase 3 to 5 covers 110. The covers 110 will be place on the desired base plates 120 as selected by the user. For example, the user may wish to place them in rooms commonly used by children, such as the nursery or play room, and not place them on rooms frequented only by adults, such as an office or a kitchen counter top. If guests are coming to visit, the covers can be easily removed to give all outlets in the home a standard look. The covers can then be replaced to the same outlet as desired.

In addition, if as the child grows, he or she begins to explore, the user can obtain additional covers 110 and now place them in other locations, such as on the plugs over counter tops in the kitchen or in the bathrooms. When the child is older, the covers 110 can be removed from all locations if desired. All outlets in the home now appear to be of the standard type, with protective covers present. The home now appears. Thus, the user has full control over where the covers to placed and can easily add or remove them as desired without the use of a screw driver or other tools.

The change can also be made without the fear of being shocked and without the user having any electrical skills. As would be expected, the base plates 120 are place on numerous sockets throughout the house by a person with the proper tools and safety training to place them around the sockets. Once the base plates 120 are in place, no further tools or training is needed to add or remove the to remove the protective cover 110. This is a great convenience since it means that any plug can be covered or rendered safe by any person without any the need of special skills or training and without fear of receiving and electric shock when removing or adding the cover 110.

The protective cover 110 may further include an opening 510. The opening 510 may be positioned at a bottom region of the protective cover and be of sufficient size such that an electrical cord coupled to a plug inserted into the electrical outlet may pass through the opening. In other embodiments the protective cover may have one large opening, as shown in FIG. 5, or have multiple smaller openings. For example, the opening 510 may be arranged to have a single large opening such that multiple cords may be passed through the same opening, or multiple smaller openings such that individual cords may be passed through.

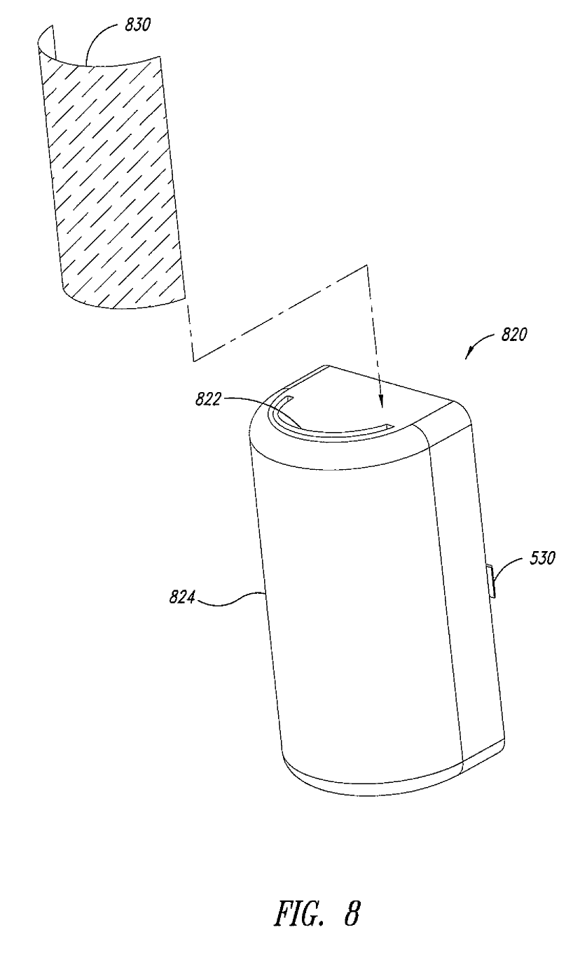

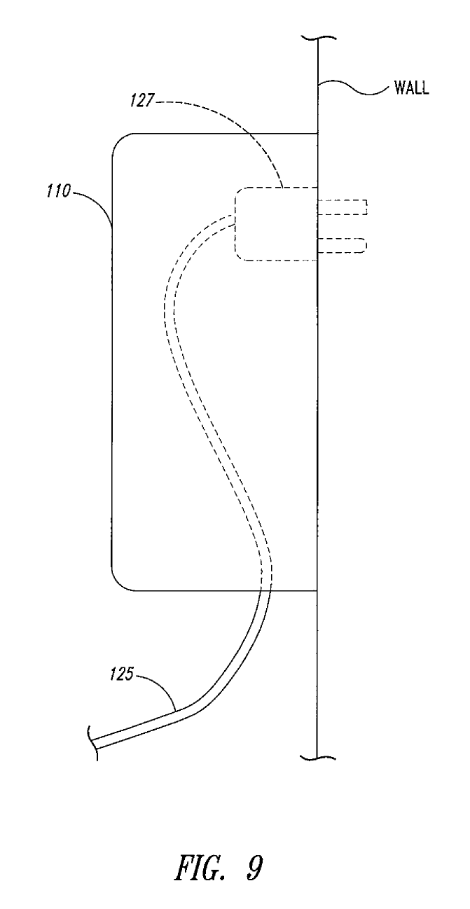

Referring to FIG. 8, other embodiments of the protective cover 110, such as a protective cover 820, may include an aperture 822 arranged to receive a printed media 830. Further, the protective cover 820 may include a front portion 824 that is transparent thus allowing the printed media 830 inserted into the aperture 822 to be visible. The picture 830 can easily be changed to match the decoration of the room of the wall plug. Thus, a matching print of wallpaper can be inserted positioned under the transparent front portion 824 so that the wall plug appears to have the same color scheme as the rest of the room. If the cover 110 is removed from the wall plug in one room, the print media 830 can also be removed and another print media that matches the room into which it will be placed is substituted. In some embodiments, the locations into which a print made be inserted include the top and bottom and any exposed sides so that the entire viewable surface of the cover 110 has a changeable color scheme that can be easily selected and easily changed by the end user. One of the embodiments thus permits the user to select the color of the cover 110 by placing easy matching of the protective cover to any room in which it is placed. Thus, the match of the color and pattern to a room can be changed to present a different look to the same outlet cover. For example, for a child's birthday or other occasion, a different picture can be inserted over the outlet cover. In other embodiments the protective media 830 may be fixed to the front portion through the use of glue or other binding means without the need for the aperture 822.

The printed media 830 may include images that are pleasant to look at, such as pictures of a family, or other familiar objects. In other embodiments the printed media 830 may include cautionary warning such as “do not touch” or other symbols that convey other messages. In still other embodiments the printed media 830 may include advertisements to be displayed. In yet other embodiments the printed media 830 may include materials meant to camouflage the protective cover. For example, if the protective cover is associated with an electrical socket on a wall that is covered in wallpaper, the printed media 830 may be a matching section of wallpaper such that the electrical socket becomes less visible.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An apparatus, comprising:
a base plate configured to be coupled to an electrical outlet;
a first aperture positioned adjacent to a first edge of the base plate;
a second aperture positioned adjacent to a first edge of the base plate;
a protective cover removably coupled to the base plate, the protective cover having an inner volume sufficient to house an electrical plug inserted into the electrical outlet and a portion of an electrical cord coupled to the electrical plug;
an opening positioned at a bottom region of the protective cover of sufficient size such that an electrical cord coupled to a plug inserted into the electrical outlet may pass through the opening;
a first tab located on the protective cover and positioned to mate with the first aperture; and
a second tab located on the protective cover and positioned to mate with the second aperture;

2. The apparatus of claim 1 wherein the protective cover is configured such that electrical connections associated with an electrical plug inserted into the electrical outlet are substantially protected from contact and impact originating from an area external to the inner volume.

3. The apparatus of claim 1 wherein the first edge of the base plate is parallel to the second edge of the base plate.

4. The apparatus of claim 1 wherein the first edge of the base plate is perpendicular to the second edge of the base plate.

5. The apparatus of claim 1 wherein the protective cover is configured in a substantially cylindrical shape.

6. The apparatus of claim 1 wherein the protective cover includes a plurality of openings of sufficient size such that electrical cords coupled to a plurality of plugs inserted into the electrical outlet may pass through the opening.

7. The apparatus of claim 1 wherein the protective cover comprises an aperture to receive printed media and an outer portion of the aperture to receive the printed material is transparent.

8. The apparatus of claim 7 wherein printed media is selected from the group comprising of a section of wallpaper, a photo, and an advertisement.

9. The apparatus of claim 1 wherein the protective cover has an outer portion to receive a decoration.
